(19) United States
(12) Patent Application Publication
(10) Pub. No.: US 2009/0077112 A1
(43) Pub. Date: Mar. 19, 2009

(54) Performance Optimized Navigation Support For Web Page Composer

(76) Inventors: Frank Albrecht, Walldorf (DE); Stephan Klevenz, Heidelberg (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/856,649

(22) Filed: Sep. 17, 2007

(51) Int. Cl. G06F 7/00; G06F 17/30

(52) U.S. Cl. 707/102; 707/E17.05

(57) ABSTRACT

A performance-optimized web content navigation system and method are disclosed. A read-optimized data structure representing a tree structure of web content is generated. The tree structure includes an ordered set of interconnected nodes, and each node representing a website or web page. The read-optimized data structure is stored in a cache accessible by a portal runtime environment, which provides access to the read-optimized data structure using a single read operation.

### BACKGROUND

This disclosure relates generally to web page navigation techniques and systems, and more particularly to performance-optimized navigation support for a web page composer tool.

With the advent of web page composer tools and other web page creation systems, large content sites, many having thousands of pages, have been created. However, these pages need to be individually integrated into user environments such as SAP AG's Enterprise Portal. Such portals utilize a portal navigation concept that is optimized for applications, but not for site integration.

Large site integration leads to problems, especially when a large number of users (i.e. thousands, if not millions) are attempting to access several thousand pages of a single site, or in other words access the single nodes of an expansive navigation tree. For this high load use case, conventional solutions based on memory caching will not work. The typical solution requires reading each node of a tree during runtime to present the navigation to the user. Such reading of the node is an “expensive” operation in terms of computing resources and time. Further, caching is not possible because of the high volume and/or high load for use cases.

### SUMMARY

In general, this document discusses a system and method for performance-optimized navigation of web content, primarily related to large content websites.

In one aspect, a computer-implemented method includes steps of generating a read-optimized data structure representing a tree structure of web content. The tree structure includes an ordered set of interconnected nodes, and each node representing a website or web page. The method further includes a step of providing access to the read-optimized data structure to a portal runtime environment with a single read operation.

In another aspect, a computer-implemented method includes the steps of generating a read-optimized data structure representing a tree structure of web content, and storing the read-optimized data structure in a cache accessible by a portal runtime environment. In yet another aspect, a performance-optimized web content navigation system includes a web page composer configured to generate a website having a plurality of web pages. The web page composer further includes a data structure generator for generating a read-optimized data structure representing a tree structure of web content for the website. The web content navigation system further includes a cache memory for storing the read-optimized data structure.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional block diagram of a system for performance-optimized navigation of web content.

FIG. 2 is a flowchart of a method for performance-optimized navigation.

Like reference symbols in the various drawings indicate like elements.

### DETAILED DESCRIPTION

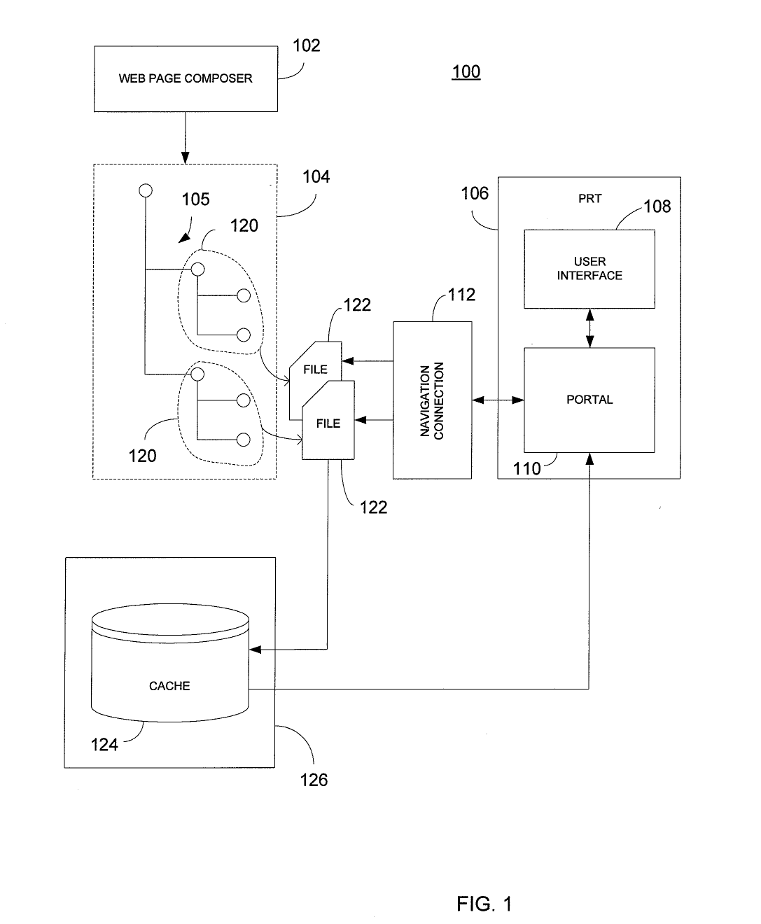

FIG. 1 is a functional block diagram of a performance-optimized navigation system 100. The navigation system 100 includes a web page composer 102 that generates a web site 104 that can be accessed and displayed in a portal runtime environment 106. The web page composer 102 can include a graphical visualization tool having a number of graphical objects representing content or functions for integration into the web site.

The web site 104 includes content that is provided in one or more web pages, and preferably arranged hierarchically such that the content can be represented by an ordered set of interconnected nodes, such as a hierarchical tree 105. In accordance with systems and methods described herein, the web site 104 is a large content site, meaning that the web site 104 may include hundreds or thousands of web pages to be accessed by many users via the portal runtime environment 106.

The portal runtime environment 106 includes a user interface 108, such as a graphical display in a physical computer display, and a portal 110 that operates according to any number of communication protocols to search one or more networks for content, aggregate the content according to user settings, and provide the integrated, arranged content to the user interface 108. In some implementations, the portal 110 is a computer program executing on a computer.

The portal 110 utilizes a navigation connection 112 to navigate one or more web sites 104 that are typically cached in a repository such as cache 124 in a knowledge management system 126. The navigation connection 112 is responsive to a query submitted by a user via user interface 108 and portal 110. Instead of having to search the cached content of large content sites, and thereby having to read single nodes, the system 100 generates a read-optimized data structure 122 after each time the tree 105 is modified.

The read-optimized data structure 122 is a special intermediate file that is independent from the number of nodes in the tree 105, and has a special file format that can be accessed by the portal 110 and navigation connection 112 by a single read operation. The read-optimized data structure contains only the lean information that is needed to build the user interface 108: i.e., displayname and description. Other information such as security settings is not included in the read-optimized data structure 122. The read-optimized data structures 122 are stored in the cache 124 of the knowledge management system 126 for access by the portal 110 and navigation connection 112.

The modifications that lead to generation of the read-optimized data structure 122 can occur at the sub-process 120 level. Accordingly, to access a subprocess 120 of a web site 104, the system 100 does not have to traverse all of the nodes in the tree 105. Further, the cache 124 does not have to be relied on to contain the entire content. Thus, the system 100 caches front-end, read-optimized data structures rather than caching backend data.

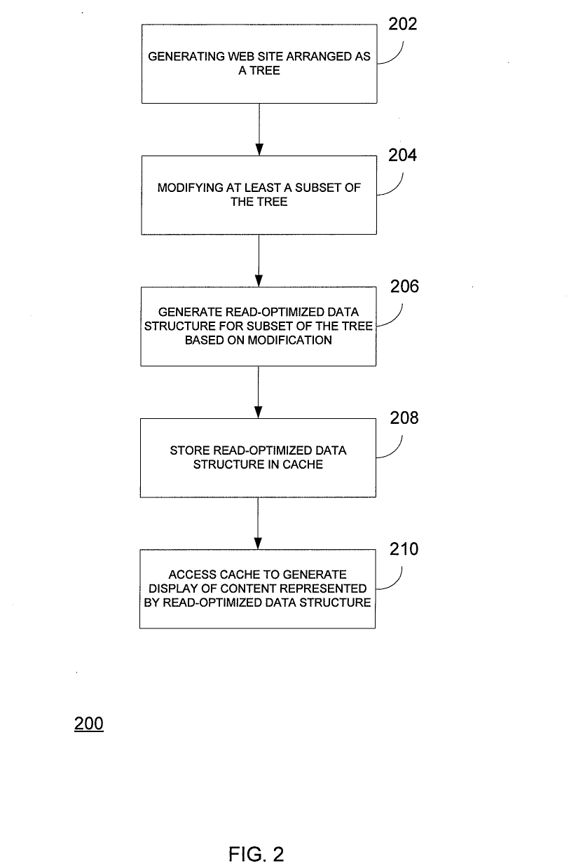

FIG. 2 is a flowchart of a method 200 for performance-optimized navigation in an enterprise portal environment. At 202, a website is generated. The website can be generated by a visual tool such as a web page composer, or by any other technique or tool. The website can be represented as a tree structure of web content, the tree structure made up of an ordered set of interconnected nodes. Each node represents a website or web page, or even content on its own. The website can be hundreds or even thousands of pages, and known as a “large content site.” The website can be a corporate intranet, for instance, or enterprise website of electronic commerce and other functions.

At 204, at least a subset of the tree is modified. For only that subset that is modified, a read-optimized data structure is generated at 206, based on that modification. The read-optimized data structure is an intermediate file of a lean structure, i.e. containing only information that is needed to generate a display of the subset of the tree in a user interface. In some implementations, a displayname is used. A short description may accompany the displayname. Other information not pertinent to the display of the subset is left out of the read-optimized data structure.

At 208, each read-optimized data structure is stored in a cache, for fast access by the portal. At 210, the portal accesses each desired read-optimized data structure with only a single read operation, to generate the display of the content represented by each read-optimized data structure. Accordingly, the method 100 provides front-end optimized data for the portal.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A computer-implemented method, comprising:
generating a read-optimized data structure representing a tree structure of web content, the tree structure comprising an ordered set of interconnected nodes, and each node representing a website or web page; and
providing access to the read-optimized data structure to a portal runtime environment with a single read operation.

2. A computer-implemented method in accordance with claim 1, wherein generating a read-optimized data structure further comprises receiving a modification to the tree structure stored in a knowledge management database.

3. A computer-implemented method in accordance with claim 1, wherein the read-optimized data structure includes a subset of the nodes of the tree structure.

4. A computer-implemented method in accordance with claim 1, wherein the read-optimized data structure comprises a file for each associated node or subprocesses of each node.

5. A computer-implemented method in accordance with claim 4, wherein the file includes a displayname and description of the associated node or subprocess.

6. A computer-implemented method in accordance with claim 1, further comprising caching the read-optimized data structure in a cache accessible by the portal runtime environment.

7. A computer-implemented method, comprising:
generating a read-optimized data structure representing a tree structure of web content, the tree structure comprising an ordered set of interconnected nodes, and each node representing a website or web page; and
storing the read-optimized data structure in a cache accessible by a portal runtime environment.

8. A computer-implemented method in accordance with claim 7, wherein generating a read-optimized data structure further comprises receiving a modification to the tree structure stored in a knowledge management database.

9. A computer-implemented method in accordance with claim 7, wherein the read-optimized data structure includes a subset of the nodes of the tree structure.

10. A computer-implemented method in accordance with claim 7, wherein the read-optimized data structure comprises a file for each associated node or subprocesses of each node.

11. A computer-implemented method in accordance with claim 10, wherein the file includes a displayname and description of the associated node or subprocess.

12. A computer-implemented method in accordance with claim 7, further comprising generating the web content with a web page composer.

13. A computer-implemented method in accordance with claim 12, further comprising arranging the web content into the tree structure.

14. A computer-implemented method in accordance with claim 13, further comprising:
receiving a modification on a subset of the ordered set of interconnected nodes; and
generating the read-optimized data structure based on the modification.

15. A performance-optimized web content navigation system comprising:
a web page composer configured to generate a website comprising a plurality of web pages, the web page composer further including a data structure generator for generating a read-optimized data structure representing a tree structure of web content for the website, the tree structure comprising an ordered set of interconnected nodes, and each node representing at least one of the web pages; and
a cache memory for storing the read-optimized data structure.

16. A system in accordance with claim 15, further comprising a portal runtime environment including a connection with the cache memory for accessing the read-optimized data structure with a single read operation to the cache memory.

17. A system in accordance with claim 16, wherein the cache memory is further configured for providing access to the read-optimized data structure to the portal runtime environment.

18. A system in accordance with claim 16, wherein the portal runtime environment includes a portal program for accessing the web content of the website.

19. A system in accordance with claim 18, wherein the portal runtime environment further includes a user interface for displaying the web content.

20. A system in accordance with claim 18, further comprising a navigation connection that is established between the portal and the web content for executing search queries on the web content on behalf of the portal.
